(19) United States
(12) Patent Application Publication
(10) Pub. No.: US 2018/0280857 A1
(43) Pub. Date: Oct. 4, 2018

(54) Filter Device for an Extractor Device

(71) Applicant: Robert Bosch GmbH, Stuttgart (DE)

(72) Inventor: Andre Ullrich, Leinfelden-Echterdingen (DE)

(21) Appl. No.: 15/760,875

(22) PCT Filed: Aug. 17, 2016
(86) PCT No.: PCT/EP2016/069515

§ 371 Date: Mar. 16, 2018

(30) Foreign Application Priority Data
Sep. 17, 2015 (DE) 102015217825.0

(51) Int. Cl. B01D 46/00; B25D 17/20; B25F 5/02

(52) U.S. Cl. CPC B01D 46/0076; B25D 17/20; B25F 5/02; B25D 2250/121; B25F 5/026; B25D 2217/0057; B01D 2279/55

(57) ABSTRACT

A filter device for an extractor device includes at least one connecting unit configured to connect to at least one filter element. The filter device also includes an oscillating unit with at least one exciter element that generates oscillations which act on the filter element at least for cleaning of the filter element. The oscillations generated by the exciter element are configured to have a frequency greater than or equal to 1 kHz.

### PRIOR ART

DE 10143941 A1 has already disclosed a filter device for a suction device, wherein the filter device comprises at least one connecting unit for connection to at least one filter element and also comprises at least one vibration unit, which has at least one exciter element for generating vibrations, which are provided in order to act on the filter element at least for the purpose of cleaning the filter element.

### DISCLOSURE OF THE INVENTION

The invention proceeds from a filter device for a suction device, having at least one connecting unit for connection to at least one filter element and having at least one vibration unit, which has at least one exciter element for generating vibrations, which are provided in order to act on the filter element at least for the purpose of cleaning the filter element.

It is proposed that the at least one exciter element is provided so that, for the purpose of cleaning the filter element, it generates vibrations of which the frequency is greater than or equal to 1 kHz. “Provided” is intended to mean, in particular, specifically designed and/or specifically equipped. That an element and/or a unit are/is provided for a certain function is intended to mean, in particular, that the element and/or the unit perform/performs and/or execute/executes this certain function in at least one use state and/or operating state. The at least one exciter element is preferably designed in the form of a vibration exciter. It is preferably the case that the at least one exciter element is designed to be driven electrically, in particular is designed to be driven electromagnetically. The at least one exciter element is preferably designed in the form of an electric exciter element, in particular is designed in the form of an electromagnetic exciter element. However, it is also conceivable for the at least one exciter element to have some other configuration regarded as being expedient by a person skilled in the art and/or to be drivable in some other way which is regarded as being expedient by a person skilled in the art, for example to be pneumatically drivable, hydraulically drivable, electrohydraulically drivable or the like. It is preferably the case, for the purpose of generating vibrations by means of the at least one exciter element, for at least one vibration generator of the exciter element to be drivable in oscillating fashion, in particular with translatory or rotary oscillation. It is particularly preferable for the vibration generator of the at least one exciter element to move in oscillating fashion, in particular with translatory or rotary oscillation, for the purpose of generating vibrations. However, it is also conceivable for the vibration generator to be movable in some other way which is regarded as being expedient by a person skilled in the art, in particular to be mounted in a movable manner. It is particularly preferable for the filter device to comprise at least one control and/or regulating unit, which is provided in order to control and/or to regulate the at least one exciter element for the purpose of generating vibrations. “Control and/or regulating unit” is intended to mean, in particular, a unit having at least one control-electronics system. A “control-electronics system” is intended to mean, in particular, a unit having a processor unit and having a memory unit and having an operating program stored in the memory unit. The vibration unit may also have a number of exciter elements other than one exciter element. The term “vibration unit” here is intended to define, in particular, a unit which is provided specifically in order to generate vibrations, in particular mechanical vibrations, which are provided in order to act on at least one element and, in particular, to cause this element to vibrate, in particular for cleaning purposes.

It is preferably the case that the connecting unit is provided for force-fitting and/or form-fitting connection to the filter element. It is preferably the case that the connecting unit is provided at least for arranging the filter element on the filter device. The connecting unit is preferably provided for arranging the filter element in a releasable manner on the filter device. As an alternative or in addition to arranging the filter element on the filter device, the connecting unit is preferably provided for connecting the filter element in a force-fitting and/or form-fitting manner to the vibration unit. However, it is also conceivable, as an alternative or in addition to force-fitting and/or form-fitting connection, for the filter element to be connected integrally to the vibration unit, in particular to the at least one exciter element, for example by means of an adhesive-bonding connection or the like. The connecting unit may have at least one accommodating element, in particular an accommodating recess, into which the filter element can be introduced at least to some extent. However, it is also conceivable for the connecting unit to have at least one clamping element for clamping the filter element firmly on a frame element and/or on an accommodating element of the connecting unit, for the connecting unit to have at least one crew-connection element for fixing the filter element on the frame element and/or on the accommodating element of the connecting unit, or for the connecting unit to have some other configuration which is regarded as being expedient by a person skilled in the art and is provided for connection to the filter element, in particular for direct connection of the vibration unit to the filter element. In particular, the filter device comprises at least the filter element. However, it is also conceivable for the filter device to comprise a multiplicity of filter elements which can be made to vibrate, in particular for cleaning purposes, preferably by means of the at least one exciter element or a multiplicity of exciter elements of the vibration unit. It is preferably the case that the at least one exciter element butts directly against the filter element. However, it is also conceivable for the at least one exciter element to be arranged on the filter element, and/or to be connected to the filter element, with the interposition of at least one element, in particular of a coupling element of the vibration unit.

The filter element can preferably be made to vibrate by means of being subjected to the action of vibrations which can be generated by the at least one exciter element. It is preferably the case that the filter element can be made to vibrate by means of the at least one exciter element. The at least one exciter element is advantageously provided so that, for the purpose of cleaning the filter element, it generates vibrations of which the frequency is in particular greater than or equal to 5 kHz, preferably greater than or equal to 10 kHz and particularly preferably greater than or equal to 16 kHz. The configuration of the filter device according to the invention can advantageously provide for low-noise cleaning of the filter element. It is advantageously possible to achieve a high level of convenience for a person operating a suction device which has at least one filter device according to the invention, since, while the filter element is being cleaned, it is possible to generate just a low level of noise as a result of the high frequencies of vibrations which can be generated by means of the at least one exciter element.

In addition, it is proposed that the at least one exciter element is provided in order to generate vibrations at a frequency of greater than or equal to 10 kHz for the purpose of cleaning the filter element. It is preferably the case that the at least one exciter element is provided so that, for the purpose of cleaning the filter element, it generates vibrations at a frequency preferably greater than or equal to 20 kHz and particularly preferably greater than or equal to 1 GHz. The configuration according to the invention can advantageously provide for a particularly low-noise cleaning operation for cleaning the filter element. The at least one exciter element can be used to generate advantageous vibration modes for cleaning the filter element.

It is also proposed that the at least one exciter element is designed in the form of an ultrasonic exciter element. The at least one exciter element is preferably provided in order to generate vibrations at a frequency of smaller than or equal to 1.5 GHz for the purpose of cleaning the filter element. The at least one exciter element is particularly preferably provided in order to generate ultrasonic vibrations for the purpose of cleaning the filter element. The configuration according to the invention can advantageously generate vibrations which act on the filter element, for the purpose of cleaning the filter element, and are inaudible to the human ear. It is advantageously possible to realize the situation where an operator is subjected to a particularly low level of noise by a cleaning operation for cleaning the filter element.

In addition, it is proposed that the at least one exciter element is provided in order to generate vibrations which, for the purpose of cleaning the filter element, act permanently or cyclically on the filter element, in particular during operation of the suction device. Preferably, in the case of vibrations acting permanently on the filter element throughout the period of operation of the suction device, the at least one exciter element generates vibrations which act permanently on the filter element during operation of the suction device. As an alternative, in particular in the case of vibrations acting cyclically on the filter element, it is conceivable for vibrations to be generated at predetermined time intervals, in particular during operation of the suction device. It is also conceivable, in the case of vibrations acting cyclically on the filter element, for vibrations to be generated following completion of a suction operation using the suction device, in order to ensure in particular advantageous cleaning of the filter element once the suction device has been used. As an alternative or in addition, however, it is also conceivable for vibrations to act dynamically on the filter element, for example in dependence on at least one filter parameter. For dynamic action of vibrations on the filter element, it is conceivable for the filter device advantageously to comprise at least one sensor unit which has at least one sensor element, which is provided in order to sense at least one filter parameter of the filter element, for example a degree of soiling of the filter element or the like, wherein in particular cleaning of the filter element takes place, by means of vibrations which can be generated by the at least one exciter element, in dependence on the filter parameter sensed. The configuration according to the invention can advantageously achieve reliable cleaning of the filter element. It is advantageously possible to provide for a high filter performance of the filter element over an at least essentially total duration of use of the filter element.

In addition, it is proposed that the vibration unit comprises at least one fastening element, which is provided in order to fix the at least one exciter element, in particular in a releasable manner, on the connecting unit and/or on the filter element. It is possible for the fastening element to be formed in one part with the at least one exciter element or separately therefrom. “One part” is intended to mean, in particular, connected at least integrally, for example by a welding process, an adhesive-bonding process, a molding process and/or some other process regarded as being expedient by a person skilled in the art, and/or is advantageously intended to mean formed in one piece, for example by being produced from one molding compound and/or by being produced by injection molding involving one or more components and advantageously from a single blank. The fastening element is preferably provided in order to fix the at least one exciter element on the connecting unit and/or on the filter element by way of a form-fitting and/or force-fitting connection. It is likewise conceivable for the at least one exciter element to be connected integrally to the connecting unit and/or the filter element, in particular by means of adhesive-bonding connection. The fastening element may be designed in the form of a latching element, of a clip element, of a threaded element, of a clamping element or of some other fastening element regarded as being expedient by a person skilled in the art. The vibration unit may also comprise a number of fastening elements other than one, these being provided in order to fix the at least one exciter element, in particular in a releasable manner, on the connecting unit and/or on the filter element. The configuration according to the invention can advantageously achieve a constructionally straightforward arrangement of the at least one exciter element on the connecting unit and/or on the filter element. It is advantageously possible to provide for reliable fastening of the filter element.

The invention also proceeds from a method for cleaning at least one filter element for a suction device, in particular by means of a vibration unit of the filter device according to the invention. It is proposed that, in at least one method step, vibrations which are generated by means of the vibration unit of the filter device at a frequency of greater than or equal to 1 kHz act on the filter element for the purpose of cleaning the filter element. It is preferably the case that, in at least one method step, the vibration unit of the filter device causes vibrations at a frequency of greater than or equal to 10 kHz, preferably greater than or equal to 20 kHz and particularly preferably smaller than 1.5 GHz, to act on the filter element for the purpose of cleaning the filter element. However, it is also conceivable for the vibrations which can be generated by means of the at least one exciter element to have a frequency which is greater than 1.5 GHz. Particularly preferably, in at least one method step, the vibration unit of the filter device causes ultrasonic vibrations to act on the filter element for the purpose of cleaning the filter element. The configuration of the method according to the invention can advantageously provide for low-noise cleaning of the filter element. It is advantageously possible to achieve a high level of convenience for a person operating a suction device which has at least one filter device according to the invention, since, while the filter element is being cleaned, it is possible to provide for just a low level of noise as a result of the high frequencies of vibrations which can be generated by means of the at least one exciter element.

A suction device having at least one filter device according to the invention is proposed in addition. The suction device may be designed in the form of a vacuum cleaner or the suction device may be designed in the form of a suction module, which can be arranged in a releasable manner on a housing of a portable power tool. In the case of the suction device being configured in the form of a vacuum cleaner, the suction device preferably comprises at least one roller unit, by means of which the suction device can be moved, in particular displaced, on an underlying surface. However, it is also conceivable for the suction device to be designed independently of a roller unit and be designed in the form of a hand-held vacuum cleaner. In the case of the suction device being configured in the form of a suction module, the suction device preferably comprises at least one connection interface, by means of which the suction device, in particular a housing of the suction device, can be connected to the housing of the portable power tool in a releasable manner by means of form-fitting and/or force-fitting connection. The configuration according to the invention can advantageously achieve the situation where a person operating the suction device is subjected to only a low level of noise by a cleaning operation of the filter element. It is advantageously possible to provide for a long service life of the suction device, since reliable cleaning of the filter element can be achieved.

In addition, it is proposed that the suction device comprises at least one housing, wherein the filter device has at least one fixing element, which is provided for fixing the at least one exciter element of the vibration unit on the connecting unit and/or on the housing. In particular, the fixing element is provided in order to interact with a fastening element of the vibration unit for the purpose of fixing the at least one exciter element of the vibration unit on the connecting unit. The fixing element is preferably designed to correspond to the fastening element of the vibration unit. The fixing element may be designed in the form of a latching element, of a clip element, of a threaded element, of a clamping element, or of some other fixing element which is regarded as being expedient by a person skilled in the art and is designed, in particular, to correspond to the fastening element. It is possible for the fixing element to be arranged on a frame element and/or an accommodating element of the connecting unit, in particular to be formed in one part with the frame element and/or the accommodating element. The configuration according to the invention can advantageously achieve the situation where vibrations which can be generated by means of the at least one exciter element are transmitted reliably to the connecting unit and thus to the filter element arranged on the connecting unit. It is advantageously possible to provide for low-noise cleaning of the filter element by means at least essentially inaudible vibrations, wherein vibrations can act reliably on the filter element as a result of the at least one exciter element being fixed by means of advantageous interaction of the fixing element and of the fastening element.

It is also proposed that the suction device should comprise at least one air-flow unit for generating an air flow for transporting particles, wherein, as seen along a main-flow direction of the air flow, the filter device is arranged at least to a great extent upstream of the air-flow unit. “A great extent” here is intended to mean, in particular, more than 30%, preferably more than 50% and particularly preferably more than 70%, of a total volume of an element and/or of a unit. The air-flow unit preferably comprises at least one fan wheel for generating an air stream. In particular, the fan wheel is provided in order to generate a negative pressure, so as to generate an air stream for transporting particles. The air-flow unit may also have some other configuration regarded as being expedient by a person skilled in the art, for example a configuration in the form of a pump or the like. The configuration according to the invention can advantageously achieve particularly effective cleaning of the filter element. It is advantageously possible to achieve a compact arrangement of the filter device.

A portable power tool, in particular a hammer drill and/or chisel hammer, having at least one suction device according to the invention is proposed in addition. It is possible for the suction device to be integrated in a housing of the portable power tool or for the suction device to be arranged in a removable manner on the housing of the portable power tool. “Portable power tool” here is intended to mean, in particular, a power tool which is intended for machining workpieces and can be transported by an operator without the use of a transporting machine. The portable power tool has, in particular, a mass which is smaller than 40 kg, preferably smaller than 10 kg and particularly preferably smaller than 5 kg. It is preferably the case that the portable power tool is designed in the form of an electrically operable portable power tool, for example of a battery-operated portable power tool and/or one which is powered through an electric cable. The portable power tool here is preferably designed in the form of a hammer drill and/or chisel hammer. However, it is also conceivable for the portable power tool to have some other configuration regarded as being expedient by a person skilled in the art, for example a configuration in the form of an angle grinder, of a router, of a jigsaw, of a grinding machine, of a garden-care machine or the like. The configuration according to the invention can advantageously provide for low-noise cleaning of the filter element. It is advantageously possible to achieve a long service life of the portable power tool. It is also advantageously possible to achieve a high level of convenience for a person operating the portable power tool, since, while the filter element is being cleaned, it is possible to provide for generation of a low level of noise as a result of the high frequencies of vibrations which can be generated by means of the at least one exciter element.

The filter device according to the invention, the method according to the invention, the suction device according to the invention and/or the portable power tool according to the invention should not be limited here to the embodiment and use described above. In particular, in order to perform a function described herein, the filter device according to the invention, the method according to the invention, the suction device according to the invention and/or the portable power tool according to the invention may have a number of individual elements, components and units as well as method steps which differs from the number mentioned herein. In addition, in the case of the ranges of values specified in this disclosure, values lying within the stated limits are also to be considered as disclosed and usable in any way desired.

### DRAWING

Further advantages can be gathered from the following description of the drawing. The drawing illustrates exemplary embodiments of the invention. The drawing, the description and the claims contain numerous features in combination. A person skilled in the art will expediently also consider the features individually and combine them to give further advantageous combinations.

In the drawing:

FIG. 1 shows a schematic illustration of a portable power tool according to the invention, in particular a hammer drill, having at least one suction device according to the invention, which comprises at least one filter device according to the invention,

FIG. 2 shows a schematic illustration of a detail-specific view of the filter device according to the invention, and

FIG. 3 shows a schematic illustration of a suction device according to the invention which is designed in the form of a vacuum cleaner and comprises at least one filter device according to the invention.

### DESCRIPTION OF THE EXEMPLARY EMBODIMENTS

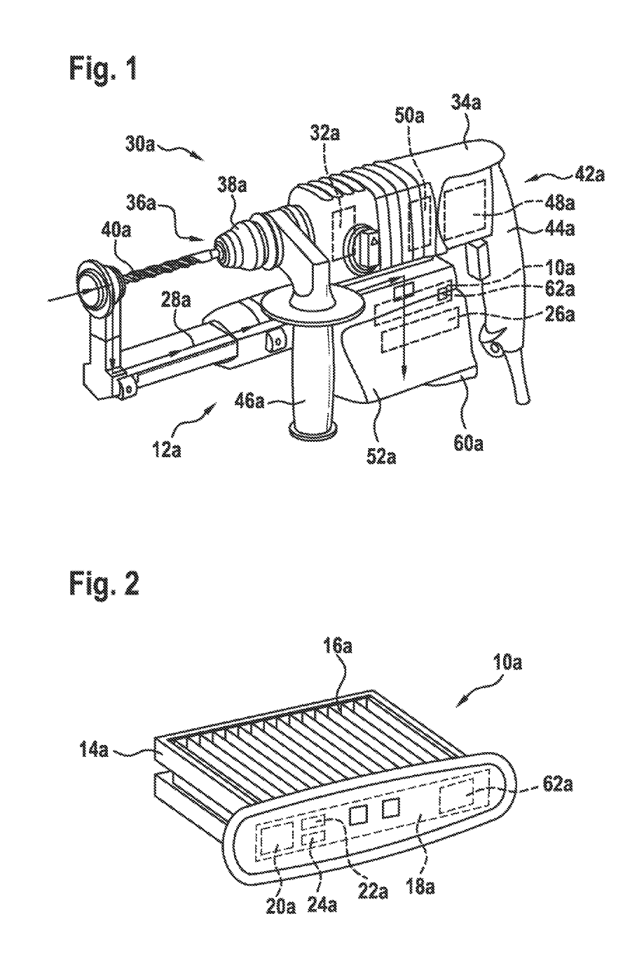

FIG. 1 shows a portable power tool 30a having at least one suction device 12a. In the exemplary embodiment illustrated in FIG. 1, the portable power tool 30a is designed in the form of a hammer drill. However, it is also conceivable for the portable power tool 30a to have some other configuration regarded as being expedient by a person skilled in the art, for example a configuration in the form of a hammer drill and/or chisel hammer or the like. The portable power tool 30a comprises at least one striking-mechanism device 32a. The portable power tool 30a also comprises a housing 34a, on a front region 36a of which a tool holder 38a of the portable power tool 30a is arranged for the purpose of accommodating a tool 40a. The tool holder 38a may be designed in the form of a drill chuck, of an SDS® tool holder or of some other tool holder regarded as being expedient by a person skilled in the art.

On a side 42a which is directed away from the front region 36a, the portable power tool 30a comprises a main handle 44a for the purposes of guiding the portable power tool 30a and of transmitting a force from an operator to the portable power tool 30a. The portable power tool 30a is preferably designed with a releasable additional handle 46a. The additional handle 46a can be fastened on the housing 34a of the portable power tool 30a, in particular in the region of the tool holder 38a, in a releasable manner via a latching connection or some other connections regarded as being expedient by a person skilled in the art.

For the purposes of generating a driving torque and of generating a striking impulse by means of the striking-mechanism device 32a, the portable power tool 30a has a drive unit 48a. The drive unit 48a is designed in the form of an electric motor. However, it is also conceivable for the drive unit 48a to have some other configuration regarded as being expedient by a person skilled in the art, for example a configuration in the form of a combustion engine, of a hybrid motor or the like. A driving torque of the drive unit 48a can be transmitted to the striking-mechanism device 32a via an output unit 50a of the portable power tool 30a at least for the purpose of generating a striking impulse. However, it is also conceivable for the portable power tool 30a to be designed independently of the output unit 50a and for the drive unit 48a to act essentially directly on the striking-mechanism device 32a for the purpose of generating a striking impulse. A striking impulse of the striking-mechanism device 32a can be generated in a manner which is already known to a person skilled in the art. The output unit 50a can be used to transmit the driving torque to the tool holder 38a, for the purpose of generating a rotary movement of the tool 40a, via a guide element of the striking-mechanism device 32a designed as a hammer tube (not illustrated specifically here), and/or via a rotary driving element (not illustrated specifically here) of the striking-mechanism device 32a, said element being arranged on the tool holder 38a, in a manner which is already known to a person skilled in the art.

The suction device 12a is designed in the form of a suction module. The suction device 12a can be arranged in a removable manner on the portable power tool 30a, in particular at an accommodating interface of the portable power tool 30a, said interface being arranged on the housing 34a of the portable power tool 30a. The accommodating interface of the portable power tool 30a is provided, in a manner which is already known to a person skilled in the art, for form-fitting and/or force-fitting connection to the suction device 12a, for example in the form of a push-in interface, of a bayonet closure, of a connecting groove, of a connecting crosspiece or the like. However, it is also conceivable, if the portable power tool 30a is configured in an alternative manner, for the suction device 12a to be integrated in the portable power tool 30a, in particular to be arranged at least to a great extent within the housing 34a of the portable power tool 30a.

The suction device 12a comprises at least one filter device 10a. The suction device 12a has at least one housing 52a, wherein the filter device 10a has at least one fixing element 24a, which is provided for fixing at least one exciter element 20a of a vibration unit 18a of the filter device 10a on a connecting unit 14a of the filter device 10a and/or on the housing 52a of the suction device 12a. The fixing element 24a is provided, in particular, in order to interact with a fastening element 22a of the vibration unit 18a for the purpose of fixing the at least one exciter element 20a of the vibration unit 18a on the connecting unit 14a and/or on the housing 52a of the suction device 12a. The fixing element 24a is preferably designed to correspond to the fastening element 22a of the vibration unit 18a. The fixing element 24a may be designed in the form of a latching element, of a clip element, of a threaded element, of a clamping element or of some other fixing element which is regarded as being expedient by a person skilled in the art and is designed in particular to correspond to the fastening element 22a of the vibration unit 18a. It is possible for the fixing element 24a to be arranged on a frame element and/or an accommodating element of the connecting unit 14a, in particular to be formed in one part with the frame element and/or the accommodating element.

The suction device 12a comprises at least one air-flow unit 26a for generating an air flow for transporting particles, wherein, as seen along a main-flow direction 28a of the air flow, the filter device 10a is arranged at least to a great extent upstream of the air-flow unit 26a. The air-flow unit 26a preferably has at least one fan wheel (not illustrated specifically here), which is already known to a person skilled in the art, for generating an air flow. In particular, the fan wheel is provided in order to generate a negative pressure, so as to generate an air flow for transporting particles. The air-flow unit 26a may also have some other element which is regarded as being expedient by a person skilled in the art and is provided in order to generate a negative pressure, so as to generate an air flow for transporting particles, for example a pump or the like. It is possible for the air-flow unit 26a, in particular when the suction device 12a is arranged on the portable power tool 30a, to be driven by means of the drive unit 48a of the portable power tool 30a, or the suction device 12a comprises a separate drive unit (not illustrated specifically here) for driving the air-flow unit 26a, in particular at least for driving the fan wheel.

The main-flow direction 28a of the air flow, which can be generated by means of the air-flow unit 26a, starts from an intake region of the suction device 12a and extends, in a manner which is already known to a person skilled in the art, in the direction of the filter device 10a to an exhaust region of the suction device 12a. The intake region is arranged, in a manner which is already known to a person skilled in the art, in the region of the tool 40a and/or of the tool holder 38a. The intake region is arranged preferably at least to some extent around the tool 40a and/or around the tool holder 38a. It is possible to provide, in a manner which is already known to a person skilled in the art, for suction of particles in the vicinity of where a workpiece is being machined.

FIG. 2 shows a detail-specific view of the filter device 10a. The filter device 10a for the suction device 12a comprises at least the connecting unit 14a for connection to at least one filter element 16a. The filter device 10a also comprises at least the vibration unit 18a, which has the at least one exciter element 20a for generating vibrations, which are provided in order to act on the filter element 16a at least for the purpose of cleaning the filter element 16a. The filter device 10a preferably comprises the filter element 16a. It is conceivable for the filter device 10a to comprise a number of filter elements 16a other than one, it being possible for these to be connected, in particular, to the connecting unit 14a or to be arranged, in particular in a removable manner, on the connecting unit 14a. The connecting unit 14a is provided for force-fitting and/or form-fitting connection to the filter element 16a. It is preferably the case that the connecting unit 14a is provided at least for arranging the filter element 16a on the filter device 10a. The connecting unit 14a is preferably provided arranging the filter element 16a in a releasable manner on the filter device 10a. As an alternative or in addition to arranging the filter element 16a on the filter device 10a, the connecting unit 14a is provided for connecting the filter element 16a in a force-fitting and/or form-fitting manner to the vibration unit 18a. It is conceivable, as an alternative or in addition to a force--fitting and/or form-fitting connection, for the filter element 16a to be connected integrally to the vibration unit 18a, in particular to the at least one exciter element 20a, for example by means of an adhesive-bonding connection or the like. The connecting unit 14a may have at least one accommodating element, in particular one accommodating recess, into which the filter element 16a can be introduced at least to some extent. However, it is also conceivable for the connecting unit 14a to have at least one clamping element for clamping the filter element 16a firmly on a frame element and/or on an accommodating element of the connecting unit 14a, for the connecting unit 14a to have at least one screw-connection element for fixing the filter element 16a on the frame element and/or on the accommodating element of the connecting unit 14a, or for the connecting unit 14a to have some other configuration which is regarded as being expedient by a person skilled in the art and is provided for connection to the filter element 16a, in particular for direct connection of the vibration unit 18a to the filter element 16a.

The vibration unit 18a comprises at least one fastening element 22a, which is provided in order to fix the at least one exciter element 20a on the connecting unit 14a and/or on the filter element 16a. The vibration unit 18a may also comprise a number of fastening elements 22a other than one, these being provided in order to fix the at least one or more exciter elements 20a of the vibration unit 18a on the connecting unit 14a and/or on the filter element 16a. It is possible for the fastening element 22a to be formed in one part with the at least one exciter element 20a or separately therefrom. The fastening element 22a is preferably provided in order to fix the at least one exciter element 20a on the connecting unit 14a and/or on the filter element 16a by way of a form-fitting and/or force-fitting connection. It is likewise conceivable for the at least one exciter element 20a to be connected integrally to the connecting unit 14a and/or the filter element 16a, in particular by means of an adhesive-bonding connection. The fastening element 22a may be designed in the form of a latching element, of a clip element, of a threaded element, of a clamping element or of some other fastening element regarded as being expedient by a person skilled in the art. The fastening element 22a is provided, in particular, in order to interact with the fixing element 16a of the filter device 10a. The fastening element 22a is preferably designed to correspond to the fixing element 16a.

The at least one exciter element 20a is provided so that, for the purpose of cleaning the filter element 16a, it generates vibrations of which the frequency is greater than or equal to 1 kHz. The at least one exciter element 20a is advantageously provided to generate vibrations at a frequency of greater than or equal to 10 kHz for the purpose of cleaning the filter element 16a. The at least one exciter element 20a is advantageously provided so that, for the purpose of cleaning the filter element 16a, it generates vibrations of which the frequency is in particular greater than or equal to 15 kHz, preferably greater than or equal to 20 kHz and particularly preferably smaller than or equal to 1.5 GHz. The at least one exciter element 20a is designed in the form of an ultrasonic exciter element. The at least one exciter element 20a is designed, in particular, in the form of an electromagnetic exciter element. However, it is also conceivable for the at least one exciter element 20a to have some other configuration regarded as being expedient by a person skilled in the art. It is particularly preferable for the suction device 12a or the filter device 10a to comprise at least one control and/or regulating unit 62a, which is provided in order to control and/or to regulate the at least one exciter element 20a for the purpose of generating vibrations. The control and/or regulating unit 62a may also be part of a control and/or regulating unit (not illustrated specifically here) of the portable power tool 30a, wherein, at least when the suction device 12a is arranged on the portable power tool 30a, the control and/or regulating unit 62a of the suction device 12a or the filter device 10a, said unit being integrated in the control and/or regulating unit of the portable power tool 30a, is provided for the purpose of controlling and/or regulating the at least one exciter element 20a.

The at least one exciter element 20a is provided in order to generate vibrations which, for the purpose of cleaning the filter element 16a, act permanently, in particular throughout the period of operation of the suction device 12a or for an entire individual operating period of the suction device 12a, or cyclically on the filter element 16a, in particular during operation of the suction device 12a. Preferably, in the case of vibrations acting permanently on the filter element 16a throughout the entire period of operation of the suction device 12a, the at least one exciter element 20a generates vibrations which act permanently on the filter element 16a during operation of the suction device 12a. As an alternative, in particular in the case of vibrations acting cyclically on the filter element 16a, it is conceivable for vibrations which act on the filter element 16a to be generated at a predetermined time interval, in particular during operation of the suction device 12a. It is also conceivable, in the case of vibrations acting cyclically on the filter element 16a, for vibrations which act on the filter element 16a to be generated following completion of a suction operation using the suction device 12a, in order to ensure in particular advantageous cleaning of the filter element 16a once the suction device 12a has been used. As an alternative or in addition, however, it is also conceivable for vibrations to act dynamically on the filter element 16a, for example in dependence on at least one filter parameter. For dynamic action of vibrations on the filter element 16a, it is conceivable for the filter device 10a advantageously to comprise at least one sensor unit which has at least one sensor element, which is provided in order to sense at least one filter parameter of the filter element 16a, for example a degree of soiling of the filter element 16a or the like, wherein in particular cleaning of the filter element 16a takes place, by means of vibrations which can be generated by the at least one exciter element 20a, in dependence on the filter parameter sensed.

For extraction of particles by suction, the air-flow unit 26a can generate a negative pressure in the suction device 12a in a manner which is already known to a person skilled in the art. The resulting negative pressure generates an air stream as a result of which particles which are to be extracted by suction are transported through the intake region of the suction device 12a, in a manner which is already known to a person skilled in the art, in the direction of the filter device 10a and into a collecting tank 60a of the suction device 12a. The particles which are to be extracted by suction are separated off at the filter element 16a, in a manner which is already known to a person skilled in the art, and remain in the collecting tank 60a at least until the collecting tank 60a is emptied.

A method for cleaning at least the filter element 16a for the suction device 12a, in particular by means of the vibration unit 18a of the filter device 10a, comprises at least one method step in which vibrations which are generated by means of the vibration unit 18a of the filter device 10a at a frequency of greater than or equal to 1 kHz, in particular greater than or equal to 16 kHz and particularly preferably smaller than or equal to 1.5 GHz, act on the filter element 16a for the purpose of cleaning the filter element 16a. In at least one method step, ultrasonic vibrations which are generated by means of the at least one exciter element 20a act on the filter element 16a for the purpose of cleaning the filter element 16a. In respect of further steps of the method for cleaning at least the filter element 16a, reference can be made to the above description of the suction device 12a and/or of the filter device 10a, since this description applies analogously to the method as well and therefore all the features relating to the suction device 12a and/or the filter device 10a are also to be considered as disclosed in respect of the method for cleaning at least the filter element 16a.

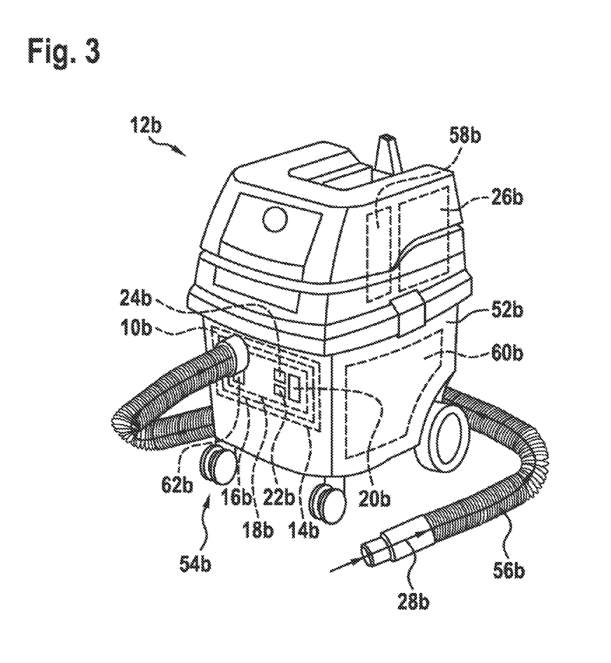

FIG. 3 shows a further exemplary embodiment of the invention. The descriptions below and the drawings are limited essentially to the differences between the exemplary embodiments, wherein, as far as components with like references are concerned, in particular as far as components with like reference signs are concerned, reference can basically also be made to the drawings and/or the description relating to the other exemplary embodiment, in particular that of FIGS. 1 and 2. In order to distinguish between the exemplary embodiments, the letter a has been placed after the reference sign in the exemplary embodiment in FIGS. 1 and 2. The letter a has been replaced by the letter b in the exemplary embodiment of FIG. 3.

FIG. 3 shows a suction device 12b having at least one filter device 10b. The suction device 12b is designed in the form of a vacuum cleaner. The filter device 10b for the suction device 12b comprises at least one connecting unit 14b for connection to at least one filter element 16b. The suction device 12b also comprises at least one vibration unit 18b, which has at least one exciter element 20b for generating vibrations, which are provided in order to act on the filter element 16b at least for the purpose of cleaning the filter element 16b. The at least one exciter element 20b is provided so that, for the purpose of cleaning the filter element 16b, it generates vibrations of which the frequency is greater than or equal to 1 kHz, in particular greater than or equal to 16 kHz and particularly preferably smaller than or equal to 1.5 GHz. The at least one exciter element 20b is provided, in particular, in order to generate ultrasonic vibrations, which act on the filter element 16b for the purpose of cleaning the filter element 16b.

The suction device 12b preferably comprises at least one roller unit 54b, by means of which the suction device 12b can be displaced on an underlying surface. However, it is also conceivable, in an alternative configuration, for the suction device 12b to be designed independently of the roller unit 54b and to be designed, in particular, in the form of a hand-held vacuum cleaner. The suction device 12b may be designed in the form of a bagless vacuum cleaner or of a vacuum cleaner with a bag.

The suction device 12b comprises at least one housing 52b, wherein the filter device 10b has at least one fixing element 24b, which is provided for fixing the at least one exciter element 20b of the vibration unit 18b of the filter device 10b on the connecting unit 14b and/or on the housing 52b of the suction device 12b. The suction device 12b has at least one air-flow unit 26b for generating an air flow for transporting particles, wherein, as seen along a main-flow direction 28b of the air flow, the filter device 10b is arranged at least to a great extent upstream of the air-flow unit 26b. For the purpose of driving the air-flow unit 26b, the suction device 12b comprises a drive unit 58b, in particular an electric motor. An air flow is generated in a manner which is already known to a person skilled in the art.

The suction device 12b comprises at least one suction hose 56b, which can be fixed on the housing 52b of the suction device 12b. The suction hose 56b can be used Co connect the suction device 12b, in a manner which is already known to a person skilled in the art, to a suction adapter, for example a floor suction adapter, a workpiece suction adapter, an upholstery suction adapter or the like, of the suction device 12b or to a connection piece of a power tool, in particular of a portable power tool (not illustrated specifically here). In respect of further features and functions of the filter device 10b and/or the suction device 12b illustrated in FIG. 3, reference can be made to the description of the filter device 10a and/or the suction device 12a illustrated in FIGS. 1 and 2.

1. A filter device for a suction device, comprising:
at least one connecting unit configured to connect to at least one filter element; and
at least one vibration unit having at least one exciter element configured to generate vibrations that act on the filter element for the purpose of cleaning the filter element,
wherein the vibrations are generated by the at least one exciter element at a frequency that is greater than or equal to 1 kHz.

2. The filter device as claimed in claim 1, wherein the vibrations are generated by the at least one exciter element at a frequency of greater than or equal to 10 kHz for the purpose of cleaning the filter element.

3. The filter device as claimed in claim 1, wherein the at least one exciter element is configured in the form of an ultrasonic exciter element.

4. The filter device as claimed in claim 1, wherein the vibrations generated by the at least one exciter element act permanently or cyclically on the filter element.

5. The filter device as claimed in claim 1, wherein the vibration unit comprises at least one fastening element that is configured to fix the at least one exciter element on one or more of the connecting unit and the filter element.

6. A method of using a filter device to clean at least one filter element (16a; 16b) for a suction device, comprising:
generating vibrations with an exciter element of a vibration unit of the filter device at a frequency of greater than or equal to 1 kHz, the vibrations acting on the filter element for the purpose of cleaning the filter element via a connecting unit configured to connect to the filter element.

7. A suction device, comprising:
a filter element for the suction device; and
at least one filter device that includes:
at least one connecting unit configured to connect to the filter element, and
at least one vibration unit having at least one exciter element configured to generate vibrations that act on the filter element for the purpose of cleaning the filter element,
wherein the vibrations are generated by the at least one exciter element at a frequency that is greater than or equal to 1 kHz.

8. The suction device as claimed in claim 7, further comprising at least one housing,
wherein the filter device has at least one fixing element configured to fix the at least one exciter element of the vibration unit on one or more of the connecting unit and the housing.

9. The suction device as claimed in claim 7, further comprising at least one air-flow unit configured to generate an air flow for transporting particles,
wherein, as seen along a main flow direction of the air flow, the filter device is arranged at least to a great extent upstream of the air-flow unit.

10. The suction device as claimed in claim 7, wherein the suction device is configured to be used with a portable power tool.

11. The filter device as claimed in claim 4, wherein the vibrations act permanently or cyclically on the filter element during operation of the suction device.

12. The suction device as claimed in claim 10, wherein the portable power tool is configured as one or more of a hammer drill and a chisel hammer.
